(19) United States
(12) Patent Application Publication
(10) Pub. No.: US 2002/0094857 A1
(43) Pub. Date: Jul. 18, 2002

(54) Gaming machine

(76) Inventor: Jason Meyer, Wollstonecraft (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/050,473

(22) Filed: Jan. 15, 2002

(30) Foreign Application Priority Data
Jan. 15, 2001 (AU) PR3214

(51) Int. Cl. A63F 13/00

(52) U.S. Cl. 463/16; 463/22

(57) ABSTRACT

A gaming machine that display an array of randomly selected symbols and paying winnings for any winning symbol combinations on any of the paylines carrying a bet. One or more of the symbols in the array has an associated sub-set secondary symbols which substitute into the array in response to a trigger, in order to award the player additional winnings for any extra winning combinations on the paylines formed using the secondary symbols. The symbols may be shown on simulated three dimensional objects such as columns of stacked cubes so that the symbols on the front face are in the array and the associated secondary symbols are visible but clearly not part of the array.

### BACKGROUND OF THE INVENTION

The present invention relates to gaming machines. The invention has been developed primarily for computerized gaming machines such as stand alone “poker machines” or Internet facilitated gaming. In light of the prevalence of these forms of gaming, the invention will be described herein with reference to that application. However, the invention is not limited to this and may be suitable for many other applications.

Gaming machines have long been known and are now one of the most common forms of gambling. Usually gaming machines will simulate a well-known game of chance. One of the oldest and best known forms of gaming machine is the rotating reel type “poker machine”. Poker machines use a series of three, four or five reels, each reel having symbols on its peripheral edge. The reels are rotated upon the placement of a bet and then stopped to produce an array of randomly arranged symbols. Winnings are paid if the random arrangement of symbols matches one of the predetermined winning combinations.

Gaming machines can “pay winnings” in a variety of ways. These include dispensing money, dispensing tokens that can be redeemed for money, or simply adding credits to a credit meter that can be used for placing future bets or redeemed as money. More recently these gaming machines have been computerized in the form of stand alone machines or simulations of the stand alone machines accessible via the Internet. Computerized machines usually award winnings in the form of credits tallied on a credit meter. In light of their wide spread use, the invention will be described in the context of this type of winnings payment mechanism.

However, those skilled in the art will readily understand that the term encompasses many other payment mechanisms.

Computerized gaming machines use a video screen display instead of physically rotating reels. The display typically presents an array of symbols in five columns and three rows equating to the symbols that would normally be seen on the five physically rotating reels of an old style mechanical machine.

Computerized machines have allowed players to simultaneously bet on the combination of symbols appearing in many different part of the array. These parts of the array are often referred to as “paylines” consisting of lines of adjacent symbols extending through the array. The symbols may be laterally adjacent each other (as in from the same row) or diagonally adjacent each other. They usually extend along each row, as well as various angled or “zigzag” lines through the array. This provides a more interesting and exciting game than the old style mechanical machines which traditionally only offered a single payline through the middle row.

A common feature on gaming machines of this type is the use of “wildcards”. Wildcards are well known in many card games as cards that have been designated as substitutes for other cards. Similarly, wildcard symbols appearing in the array of symbols on a gaming machine can substitute for other symbols.

The appearance of a wildcard on any paylines carrying a bet is beneficial as it increases the probability of forming a winning combination. Wildcards can also provide an incentive for players to place bets on most, if not all the available paylines. Each symbol in the array will usually be part of more than one payline. Therefore, the probability of a winning payline (that is, a payline which carries a bet and shows a winning combination of symbols) is significantly increased if one or more wildcards appear in an array in which the player has bet on all available paylines.

Despite these significant benefits, players are now very familiar with the wildcard feature and its appearance in an array of symbols does not provide a strong sense of bonus or incentive for many seasoned players.

### SUMMARY OF THE INVENTION

In accordance with the present invention, there is provided a gaming machine which overcomes or ameliorates at least one of the disadvantages of prior gaming machines, or provides a useful alternative.

Further, in accordance with the present invention, there is provided a gaming machine comprising:

means adapted to display an array of symbols randomly selected from a set of symbols; and

means adapted to pay winnings on the occurrence of predetermined winning combinations of symbols within the array;

wherein at least one of the symbols is associated with a subset of secondary symbols, such that one of the secondary symbols substitutes for the primary symbol in response to a trigger, and winnings are paid for any winning combinations in the array with the primary symbol and for any additional winning combinations in the array which contain the secondary symbol.

By configuring the machine so that some symbols can only substitute for certain other symbols, rather than just using wildcards which substitute for all other symbols, the game designer has many more mathematical possibilities on which to structure the game.

Preferably, the primary and the secondary symbols are displayed on a simulated three dimensional object within the array so that the three dimensional object moves in order to substitute the secondary symbol into the array.

In a further preferred form, the three dimensional object is a rectangular prism with the primary symbol initially on the front face and the secondary symbol is on another face such that the prism rotates in order to substitute the secondary symbol into the array. In this form, it is further preferred if the secondary symbol is visible prior to the occurrence of the trigger but displayed in a manner that clearly indicates that it is not yet part of the array.

In one particularly preferred form, the array has a plurality of the prisms vertically stacked into at least two columns such that initially each of the symbols shown in the array are the primary symbols, which are on the front face of each of the prism, and the respective secondary symbols are shown on the respective side faces of the prisms. Preferably, the prisms are cubes. In this embodiment, the trigger may cause only one of the cubes to rotate or alternatively, several of the cubes to rotate. In a still further preferred form, all the cubes in one of the columns may rotate, or all the columns rotate.

Preferably, the trigger is a predetermined combination of symbols in the array. In one embodiment, the trigger is a predetermined combination of the secondary symbols shown on the side faces of the cubes.

Still further in accordance with the present invention, there is provided a gaming machine comprising:

means adapted to display an array of symbols randomly selected from a set of symbols; and

means adapted to pay winnings on the occurrence of predetermined winning combinations of symbols within the may;

wherein at least one of the symbols in the array is shown on an image of a three dimensional object such that, in response to a trigger, the image of the three dimensional object moves in order to substitute a different symbol into the array.

Preferably, winnings are paid on any winning combinations in the array having the initial symbol shown on the three dimensional object as well as any additional winning combinations in the array having the different symbol.

In a further preferred form, the three dimensional object is a cube with symbols on at least two faces, one of the faces being the front face and the different symbol being on any of the other faces, such that, the cube rotates in response to the trigger to bring the different symbol into the array.

Preferably, the array has a plurality of cubes stacked into two or more columns and all the cubes in one of the columns rotate in response to the trigger.

Preferably, the trigger is a predetermined combination of at least two adjacent symbols, wherein the combination of symbols is graphically represented in the array as a single symbol of greater size than the individual symbols.

The present invention provides the mathematical basis for a much greater range of outcomes for the game. In addition to having wildcards appear in the array, the game allows certain symbols to be swapped for alternative symbols which may or may not be a wildcard. Accordingly, the game designer has more flexibility with regard to the level of winnings, the frequency of winning and all other aspects influencing the gaming experience. Furthermore, the use of a three dimensional style of display and oversized symbols, is more interesting and dynamic and therefore holds greater visual appeal for players.

### BRIEF DESCRIPTION OF THE DRAWINGS

A preferred embodiment of the present invention will now be described, by way of example only, with reference to the accompanying drawings in which:

FIG. 1 shows a schematic representation of the display of a gaming machine according to the present invention;

FIG. 2 shows the display during a trigger event; and

FIG. 3 shows the display after the trigger event.

### DETAILED DESCRIPTION OF THE INVENTION

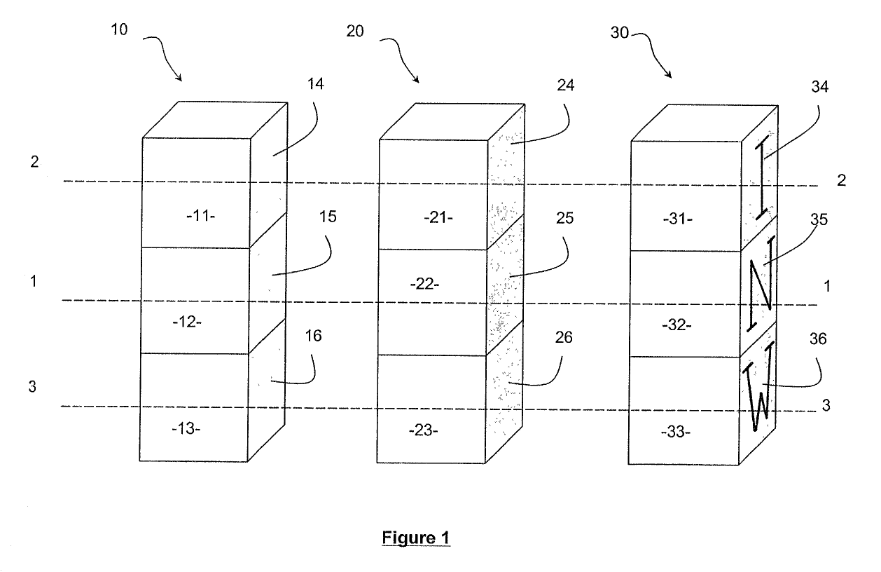

Referring to FIG. 1, the gaming machine display shows cubes vertically stacked into three columns 10, 20 and 30. The front face 11, 12, 13, 21, 22, 23, 31, 32, and 33 of each cube has a symbol chosen from a set of symbols in order to form an array of randomly arranged symbols. Paylines 1-1 to 2-2 and 3-3 extend through the array to define the lines of symbols available for carrying a bet. If payline 1-1 is carrying a bet and the symbols appearing at 12, 22 and 32 match any of the predetermined winning combinations, then payline 1-1 is a winning payline and winnings are awarded to the player.

For the purposes of clarity, the example shown uses only 3 columns and 3 paylines. However, in reality it would be typical for the machine to have five or more columns each having more than three cubes. The number of paylines would typically exceed twenty. Columns, cubes and paylines are variables that are set at the discretion of the game designer.

Assuming that all three paylines 1-1, 2-2 and 3-3 are carrying a bet, only the symbols shown on the front face of the cubes (11, 21, 31, 12, 22, 32, 13, 23, and 33) are considered when calculating any winnings. Symbols on the adjacent side faces of the cubes (14, 24, 34, 15, 25, 26, 16, 26, and 36) are visible to the player but not used for the purpose of assessing any winnings.

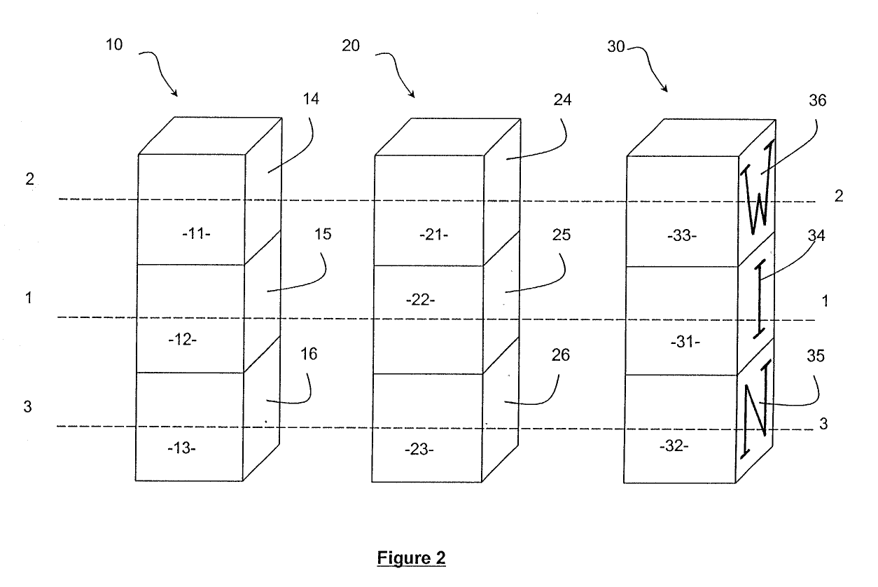

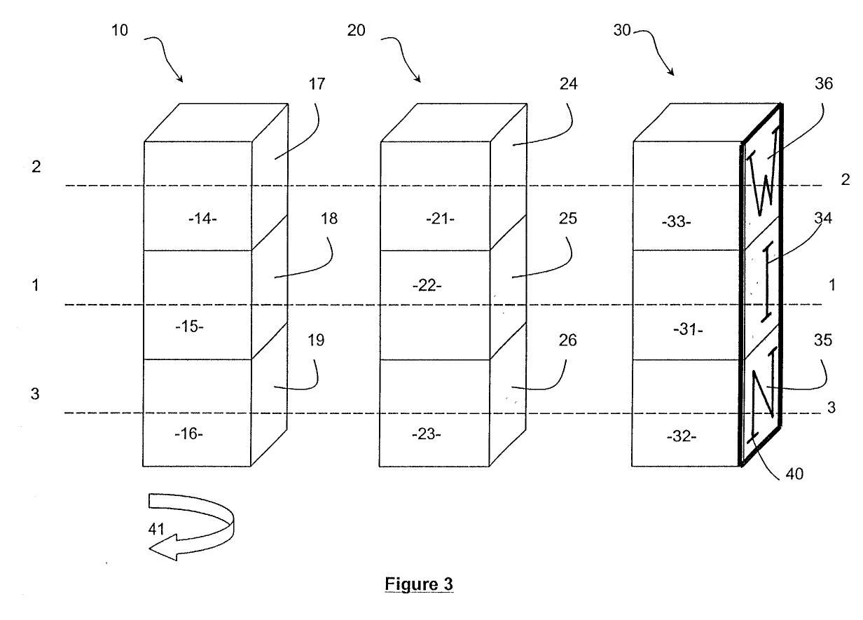

Referring to FIG. 2, the machine is configured such tat the combination of symbols 36, 34 and 35 (in that order), is a trigger combination. Any winnings from winning paylines containing symbols 11, 12 and 13 are awarded to the player. Then as shown in FIG. 3, the cubes in column 1 rotate in the direction shown by arrow 41 such that the symbols 14, 15 and 16 on the adjacent side faces are moved into the array. Winnings are then awarded for any additional winning combinations that appear in the paylines having 14, 15 and 16.

To enhance the visual impact associated with the occurrence of the trigger, the combination of symbols 36, 34 and 35 is graphically displayed as if it were one oversized symbol 40 instead of three individual symbols. As shown in the Figures, if the individual symbols 36, 34 and 35 that comprise the winning combination are selected such that, when combined in the specified way, they spell a word or form a complete image or picture. In the example shown, the individual symbols 34, 35 and 36 can be combined in order to form the word “WIN”which is a simple yet effective way of signifying the trigger event as well as forming an oversized symbol 40.

It will be appreciated that this invention increases the number of possible outcomes which provides the mathematical basis for the game designer to exercise greater control over the nature and character of the game. Furthermore, the invention can be used in conjunction with standard wild card techniques or any desired variations to this theme. For example, the occurrence of any oversize symbols in the array can also function as wild cards which substitute for any other symbol. An oversized wild card in a standard 5×3 symbol array is likely to pass through most of the available paylines and its size has more visual impact, thus giving the player a strong sense of bonus when it appears.

The invention has been described herein by way of example only. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A gaming machine comprising:
means adapted to display an array of symbols randomly selected from a set of symbols; and
means adapted to pay winnings on the occurrence of predetermined winning combinations of symbols within the array;
wherein at least one of the symbol is associated with a subset of secondary symbols, such that, one of the secondary symbols substitutes for the primary symbol in response to a trigger, and winnings are paid for any winning combinations in the array with the primary symbol, and for any additional winning combinations in the array with the secondary symbol.

2. A gaming machine according to claim 1 wherein the primary and the secondary symbols are displayed on a simulated three dimensional object within the array such that the three dimensional object moves in order to substitute the secondary symbol into the array.

3. A gaming machine according to claim 2 wherein the simulated three dimensional object is a rectangular prism with the primary symbol initially on the front face and the secondary symbol is on another face such that the prism rotates in order to substitute the secondary symbol into the array.

4. A gaming machine according to claim 3 wherein the secondary symbol is visible prior to the occurrence of the trigger but displayed in a manner that clearly indicates that it is not yet part of the array.

5. A gaming machine according to claim 4 wherein the array has a plurality of prisms vertically stacked into at least two columns and wherein, initially each of the symbols shown in the array are the primary symbol, which are on the front face of each of the prism, and the respective secondary symbols are shown on the respective side faces of the prisms.

6. A gaming machine according to claim 5 wherein the prisms are cubes and the trigger causes only one of the cubes to rotate.

7. A gaming machine according to claim 5 wherein the trigger causes several cubes to rotate.

8. A gaming machine according to claim 5 wherein all the cubes in one of the columns rotate.

9. A gaming machine according to claim 5 wherein all the cubes in all the columns rotate.

10. A gaming machine according to claim 3 wherein the trigger is a predetermined combination of the symbols in the array.

11. A gaming machine according to claim 3 wherein the trigger is a predetermined combination of the secondary symbols shown on the side faces of the cubes.

12. A gaming machine comprising:
means adapted to display an array of symbols randomly selected from a set of symbols; and
means adapted to pay winnings on the occurrence of predetermined winning combinations of symbols within the array;
wherein at least one of the symbols in the array is shown on an image of a three dimensional object such that, in response to a trigger, the image of the three dimensional object moves in order to substitute a different symbol into the array.

13. A gaining machine according to claim 12 wherein winnings are paid for any winning combinations in the array having the initial symbol shown on the three dimensional object, and for any additional winning combinations in the array having the different symbol.

14. A gaming machine according to claim 13 wherein the three dimensional object is a cube with symbols on at least two faces, wherein one of the faces is the front face and wherein a different symbol is on any of the other faces, such that the cube rotates in response to the trigger to bring the different symbol into the array.

15. A gaming machine according to claim 14 wherein the array has a plurality of cubes stacked into at least two columns and all the cubes in at least one column rotates in response to the trigger.

16. A gaming machine according to claim 15 wherein the trigger is a predetermined combination of at least two adjacent symbols, wherein the combination of symbols is graphically represented in the array as a single symbol of greater size than the individual symbols.

17. A method for operating a gaming machine comprising:
displaying an array of symbols randomly selected from a set of symbols; and
paying winnings on the occurrence of predetermined winning combinations of symbols within the array;
wherein at least one of the symbol is associated with a subset of secondary symbols, such that, one of the secondary symbols substitutes for the primary symbol in response to a trigger, and winnings are paid for any winning combinations in the array with the primary symbol, and for any additional winning combinations in the array with the secondary symbol.

18. A method for operating a gaming machine comprising:
displaying an array of symbols randomly selected from a set of symbols; and
paying winnings on the occurrence of predetermined winning combinations of symbols within the array;
wherein at least one of the symbols in the array is shown on an image of a three dimensional object such that, in response to a trigger, the image of the three dimensional object moves in order to substitute a different symbol into the array.
